(19) United States
(12) Patent Application Publication
(10) Pub. No.: US 2008/0072336 A1
(43) Pub. Date: Mar. 20, 2008

(54) Electronic device

(75) Inventors: Tzu-Hsien Tung, Taipei (TW); Ming-Fang Hsu, Taipei (TW); Po-Jen Ke, Taipei (TW)

Correspondence Address: BACON & THOMAS, PLLC, 625 SLATERS LANE, FOURTH FLOOR, ALEXANDRIA, VA, 22314, US

(73) Assignee: ASUSTek COMPUTER INC., Taipei (TW)

(21) Appl. No.: 11/896,781

(22) Filed: Sep. 6, 2007

(30) Foreign Application Priority Data
Sep. 19, 2006 (TW) 95134622

(51) Int. Cl. G06F 21/00

(52) U.S. Cl. 726/34

(57) ABSTRACT

An electronic device includes a body, a cover, an electronic switch, an input interface and a control unit. The body stores a default password and has an electrical slot. The cover is provided on the body and able to open and close thereon. When the cover closes, it covers the electrical slot. The electronic switch is provided at the body to lock or release the cover. When the electronic device is not powered on, the electronic switch locks the cover. The input interface is provided at the body for inputting an access password. The control unit is electrically connected to the input interface and the electronic switch respectively. The control unit is provided inside the body for receiving the access password and obtaining the default password. When the access password is matched with the default password, the control unit controls the electronic switch to release the cover.

This application claims the benefit of Taiwan application Serial No. 95134622, filed Sep. 19, 2006, the subject matter of which is incorporated herein by reference.

### BACKGROUND OF THE INVENTION

1. Field of the Invention

This invention relates to an electronic device and, more particularly, to an electronic device which can prevent its expansion card to be easily removed.

2. Description of the Related Art

Nowadays, most current miniaturized electronic devices such as personal digital assistants (PDA), mobile telephones and portable media players can support expanded memory cards to store more data. However, since most electronic devices hold a memory card by a push-push mechanism, and the memory card can be put in and taken out easily by pressing without any special protective function, the risk of the memory card being stolen is high.

### BRIEF SUMMARY OF THE INVENTION

The objective of this invention is to provide an electronic device which can protect an expanded card, such as a memory card, by using an electromagnetic switch collocating with a control software program and mechanism design.

According to the objective of this invention, an electronic device including a body, a cover, an electronic switch, an input interface, and a control unit is provided. The body of the electronic device stores a default password. The cover is provided on the body and able to open and close thereon. The electronic switch is provided at the body to lock or release the cover. When the electronic device switches off, the electronic switch locks the cover. The input interface is provided at the body for inputting an access password. The control unit is provided in the body for receiving the access password and electrically connected to the input interface and the electronic switch respectively. When the access password matches the default password, the control unit controls the electronic switch to release the cover.

These and other features, aspects, and advantages of the invention will become better understood with regard to the following description, appended claims, and accompanying drawings.

### BRIEF DESCRIPTION OF THE DRAWINGS

FIG. 1 is a block diagram showing the function of protecting the memory card of an electronic device of a preferred embodiment of this invention.

FIG. 2 is a schematic diagram showing a close state of the cover of an electronic device of a preferred embodiment of this invention.

FIG. 3 is a schematic diagram showing an open state of the cover of an electronic device of a preferred embodiment of this invention.

### DETAILED DESCRIPTION OF THE EMBODIMENTS

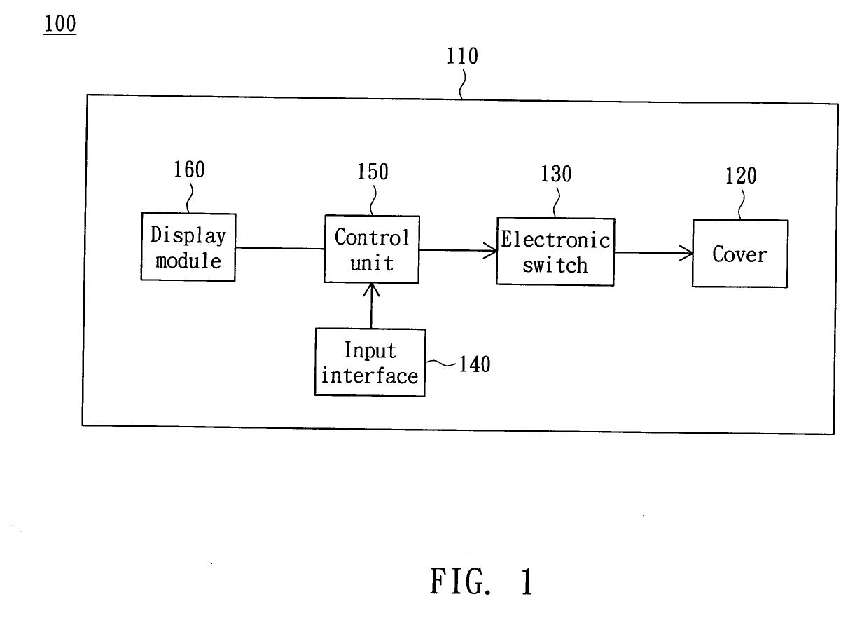

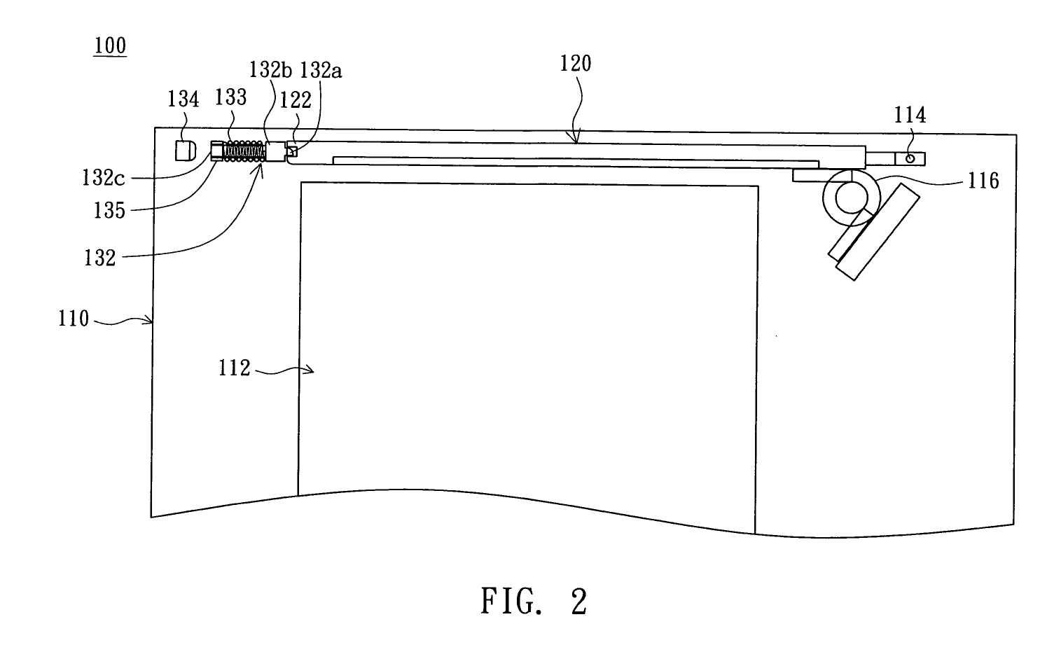

Please refer to FIG. 1 which is a block diagram showing the function of memory card protection of an electronic device of a preferred embodiment of this invention. The electronic device 100 of this invention can be a mobile telephone, a personal digital assistant (PDA), an intelligent mobile phone, or a portable media player. The electronic device 100 includes a body 110, a cover 120, an electronic switch 130, an input interface 140, and a control unit 150. Please refer to FIG. 2 simultaneously, which shows the close state of the cover of an electronic device of a preferred embodiment of this invention. The body 110 stores a default password, and has an electrical slot 112 such as a memory card slot. The cover 120 is provided on the body 110 and able to open and close thereon. The electrical slot 112 can be electrically connected to an expansion card such as a memory card. When the cover 120 closes, it covers the electrical slot 112. The electronic switch 130 is provided on the body 110 to lock or release the cover 120. When the cover 120 closes and the electronic device 100 switches off, the electronic switch 130 locks the cover 120.

The input interface 140 such as a keyboard of a mobile telephone or an external connected keyboard of a PDA is provided on the body 110 for inputting an access password. The control unit 150 is electrically connected to input interface 140 and electronic switch 130 respectively, and the control unit 150 is provided in the body 110 for receiving an access password and obtaining the default password. When the access password matches the default password, the control unit 150 controls the electronic switch 130 to release the cover 120. When the access password does not match the default password for a default number of times, the electronic switch 130 will be locked preferably by the control unit 150, and cannot be opened by inputting the access password so that the memory card can be secured. Moreover, the electronic device 100 further includes a display module 160 such as a liquid crystal or light emitting diode display screen for displaying the inputted password so that users can input and modify the password easily.

As shown in FIG. 2, the cover 120 further includes a first joint part 122, and the electronic switch 130 further includes a locking module 132 and an electromagnetic module 134. The locking module 132 is slidingly provided in the body 110. The locking module 132 has a first end and a second end, and the first end has a second joint part 132a. When the first joint part 122 interferes with the second joint part 132a, the cover 120 is locked with the body 110. The electromagnetic module 134 is provided on the body 110.

The locking module 132 further includes a protrusion 132b and a pin 132c connecting with the protrusion 132b. The second end of the locking module 132 lies on the pin 132c, while the first end of the locking module 132 lies on another side of the protrusion 132b relatively to the pin 132c. In this embodiment, an elastic element 133 is preferably inserted by the pin 132c, and the baffle 135 is fixed on the body 110. The pin 132c is inserted into the baffle 135, and can be moved relatively to the baffle 135. The elastic element 133, such as a spring, lies between the baffle 135 and the protrusion 132b.

In this embodiment, the first joint part 122 has a recess and the second joint part 132a has a convex part, so that the first joint part 122 can interfere with the second joint part 132a. Wherein, the convex part can preferably be a fillet. Therefore, when the cover 120 is pressed down and contacts with the fillet, the cover 120 exerts a lateral component force on the second joint part 132a, which makes the protrusion 132b draw back, and the elastic element 133 is against the cover 135 and generates an corresponding elastic stress. When the convex part of the second joint part 132a reaches the recess of the first joint part 122, the elastic stress produced by elastic module 133 pushes the convex part into the recess to fix the cover 120 with the body 110. There is no limitation thereon, as a further embodiment, the first joint part 122 can have a convex part, while the second joint part 134a has a recess.

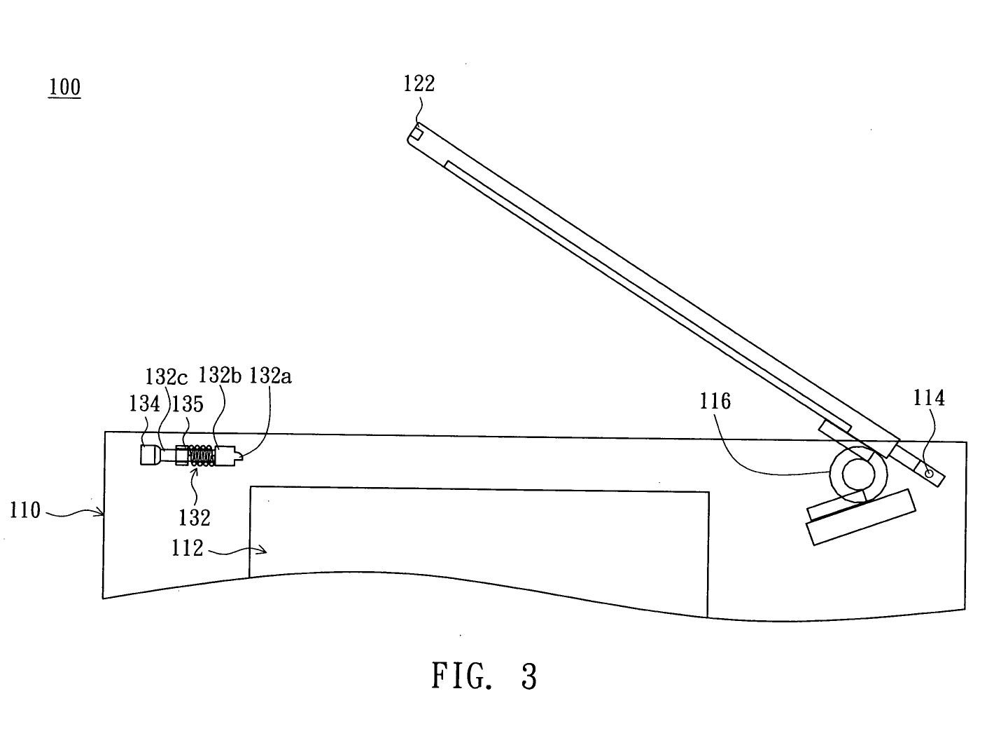

Please refer to FIG. 3, which is a schematic diagram showing an open state of an electronic device of a preferred embodiment of this invention. When the electromagnetic module 134 electrically conducts, a magnetic force is produced due to the electromagnetic action to attract and move the second end of the locking module 132. That is, the pin 132c is attracted so that the first joint part 122 and the second joint part 132a is separated from each other, and the cover is opened. The material of the pin 132c is magnetisable material such as iron or nickel. In this embodiment, the pin 132c and the protrusion 132b are preferably integrally formed. Since one end of the cover 120 is pivotally connected to the body 110 by the pivotal part 114, a torsional spring 116 is provided on the body 110 adjacent to the end. When the electronic switch 130 switches on, the cover 120 will be opened relatively to the body 110 by an elastic force of the torsional spring 116.

The electronic device disclosed by the above embodiment of this invention utilizes an electronic switch with the password-input method and cooperate with a proper protection mechanism to protect the memory card. Since the action force is an electromagnetic force, the password must be inputted in power-on state to active the protect device so that the security of the memory card is assured.

Although the invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An electronic device comprising:
a body storing a default password;
a cover provided on the body and able to be open or closed thereon;
an electronic switch provided at the body to lock or release the cover, the electronic switch locking the cover when the electronic device switches off;
an input interface provided at the body for inputting an access password; and
a control unit electrically connected to the input interface and the electronic switch, respectively, wherein the control unit is provided in the body for receiving the access password, and when the access password matches the default password, the control unit controls the electronic switch to release the cover.

2. An electronic device according to claim 1, wherein the cover further has a first joint part, and the electronic switch further comprises:
a locking module slidingly provided in the body, the locking module having a first end and a second end, the first end having a second joint part, and when the first joint part interferes with the second joint part, the cover is locked with the body; and
an electromagnetic module provided on the body, and when the electromagnetic module is transmitted by the electricity, it produces a magnetic force which attracts and moves the second part of the locking module so that the first joint part and the second joint part are separated from each other to release the cover.

3. An electronic device according to claim 2, wherein the locking module further comprises a protrusion and a pin connected to the protrusion, and the second end lies on the pin, while the first end lies on another side of the protrusion relatively to the pin.

4. An electronic device according to claim 3, the electronic device further comprising:
an elastic element inserted by the pin, and
a baffle fixed on the body, wherein the pin inserts into the baffle and is able to move relatively to the baffle, the elastic element is provided between the baffle and the protrusion.

5. An electronic device according to claim 3, wherein the pin is made by magnetisable material.

6. An electronic device according to claim 5, wherein the pin and the protrusion are integrally formed.

7. An electronic device according to claim 5, wherein the magnetisable material is iron or nickel.

8. An electronic device according to claim 2, wherein the first joint part has a recess, and the second joint part has a convex part.

9. An electronic device according to claim 8, wherein the convex part has a fillet.

10. An electronic device according to claim 2, wherein the first joint part has a convex part, and the second joint part has a recess.

11. An electronic device according to claim 10, wherein the convex part has a fillet.

12. An electronic device according to claim 1, wherein one end of the cover is pivotally connected to the body, and a torsional spring is provided on the body adjacent to the end, and when the electronic switch switches on, the cover is opened from the body by the elastic force of the torsional spring.

13. An electronic device according to claim 1, wherein the body has an electrical slot which can be electrically connected with an expansion card, and when the cover closes, the cover covers the electrical slot.

14. An electronic device according to claim 1, wherein the input interface is provided on the body.

15. An electronic device according to claim 1, further comprising a display module for displaying the inputted password.

16. An electronic device according to claim 1, wherein when the access password does not match the default password for a default number of times, the electronic switch can not be switched on by inputting the same access password.

17. An electronic device according to claim 1, wherein the electronic device can be a mobile telephone, a personal digital assistant, an intelligent mobile phone, or a portable media player.
